(19) United States
(12) Patent Application Publication
(10) Pub. No.: US 2009/0294429 A1
(43) Pub. Date: Dec. 3, 2009

(54) CHIP-LIKE HEAT SOURCE EQUIPMENT

(75) Inventors: Chien-An CHEN, Taipei (TW); Yuan-Sen Tsai, Taipei (TW); Min-Lang Chen, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/169,728

(22) Filed: Jul. 9, 2008

(30) Foreign Application Priority Data
May 28, 2008 (TW) 097209359

(51) Int. Cl. H05B 1/00

(52) U.S. Cl. 219/200

(57) ABSTRACT

A chip-like heat source equipment includes a simulation package, a thermal conductor, a heat source, a thermal grease, and an insulating pad. The thermal conductor is disposed in the simulation package, and has a simulated heat source region on one side. The heat source is disposed on another side of the thermal conductor having the simulated heat source region. The insulating pad is covered on the other side of the thermal conductor having the simulated heat source region and the heat source, such that the heat energy generated by the heat source is transferred to the simulated heat source region via the thermal conductor. In this manner, a structure having the heat generating states similar to that of the real chip is formed.

### CROSS-REFERENCE TO RELATED APPLICATIONS

This non-provisional application claims priority under 35 U.S.C. § 119(a) on Patent Application No(s). 097209359 filed in Taiwan, R.O.C. on May 28, 2008 the entire contents of which are hereby incorporated by reference.

### BACKGROUND OF THE INVENTION

1. Field of Invention

The present invention relates to a chip-like heat source equipment, and more particularly to a heat source equipment capable of closely simulating heat generating states of a chip.

2. Related Art

With rapid development of information computer industry, computers are highly related to daily life. Therefore, in a trend that the users rely much on the computers, higher requirements are raised for the performance of the computer, and one of the major factors affecting the computer performance is the heat dissipation efficiency.

Among various components of a computer, the central processing unit (CPU), or sometimes just called processor, is the most critical. The CPU is mainly responsible for performing arithmetic and logic operations, and decoding instructions in the computer to control the operation of the computer. Currently, in the manufacturing technique of the CPU, a cache memory (where the computer stores the main operation data in advance) is also disposed in the CPU to greatly speed up the operation of the CPU.

Like other chip products, the CPU itself is a chip and manufactured through similar processes. However, the CPU is an integrated chip containing up to millions of transistors (i.e., integrated circuits for executing the built-in instructions of the computer). In the integrated circuits, a dedicated instruction set (basic programs for commanding the computer to work) is stored in advance, which enables the general work of the computer. Therefore, the CPU is also called the heart of the computer.

However, the computer after a long time use or executing more programs may have a higher temperature. Therefore, the heat dissipation effect of the CPU is critical to the operating efficiency of the computer.

At present, the computer assembly factories all use the test CPUs provided by the manufacturers to simulate the thermal flow states of the CPU, so as to design an optimal installation position and heat dissipation mode for the CPU. However, the test CPUs are all fabricated by the manufacturers through semiconductor processes, and provided with a limited number for the computer assembly factories to perform test. Thus, the computer assembly factories usually have to weld external power lines by themselves. Due to the difficulties in processing, the test CPUs may be damaged in welding.

Furthermore, the chip has many specifications such as CPU, south bridge chip, north bridge chip, graphic chip, network chip, and hard drive controller chip. However, currently, the manufacturers only provide the CPUs and north bridge chips for the computer assembly factories to test, so the computer assembly factories cannot test the chips of all specifications, and further cannot provide the optimal heat dissipation modes of all chips.

### SUMMARY OF THE INVENTION

Accordingly, the present invention is mainly directed to a chip-like heat source equipment capable of constructing any chip specifications by way of mechanical processing, so as to solve the problems or overcome the defects that it is difficulties in processing and the test CPUs may be damaged in processing in the prior art.

The present invention provides a chip-like heat source equipment, which includes a simulation package, a thermal conductor, a heat source, and an insulating pad. The simulation package is formed with a through-hole. The thermal conductor is disposed in the simulation package, and has a simulated heat source region on one side and exposed by the through-hole. The heat source having an electrical contact is disposed on another side of the thermal conductor having the simulated heat source region, for receiving the power source and generating the heat energy. The insulating pad is covered on the other side of the thermal conductor having the simulated heat source region and the heat source, such that the heat energy generated by the heat source is transferred to the simulated heat source region via the thermal conductor.

In another embodiment of the present invention, the present invention provides a chip-like heat source equipment, which includes a simulation package, a heat source, and an insulating pad. The simulation package has at least one thermal conductor, and a simulated heat source region corresponding to the thermal conductor on one side. The heat source having an electrical contact is disposed on another side of the simulation package having the simulated heat source region, for receiving the power source and generating the heat energy. The insulating pad is covered on the other side of the simulation package having the simulated heat source region and the heat source, such that the heat energy generated by the heat source is transferred to the simulated heat source region via the thermal conductor.

In view of the above, the present invention achieves effect of constructing a heat source equipment applicable to various specifications and having a similar appearance through the simple mechanical processing, thereby achieving the simulation of the thermal conduction and flow resistance states of a real chip.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a chip-like heat source equipment according to a first embodiment of the present invention;

FIG. 2A is a schematic view illustrating processing of a chip-like heat source equipment according to the first embodiment of the present invention;

FIG. 2B is a schematic view illustrating processing of a chip-like heat source equipment according to the first embodiment of the present invention;

FIG. 3A is a perspective view of a chip-like heat source equipment according to the first embodiment of the present invention;

FIG. 3B is a perspective view of a chip-like heat source equipment according to the first embodiment of the present invention;

FIG. 4 is an exploded view of a chip-like heat source equipment according to a second embodiment of the present invention;

FIG. 5A is a schematic view illustrating processing of a chip-like heat source equipment according to the second embodiment of the present invention;

FIG. 5B is a schematic view illustrating processing of a chip-like heat source equipment according to the second embodiment of the present invention;

FIG. 6A is a perspective view of a chip-like heat source equipment according to the second embodiment of the present invention; and

FIG. 6B is a cross-sectional view of a chip-like heat source equipment according to the second embodiment of the present invention.

### DETAILED DESCRIPTION OF THE INVENTION

The objectives, structures, features, and functions of the present invention will be illustrated in detail in the following embodiments.

The chip-like heat source equipment of the present invention simulates heat generating states of various specifications such as a CPU, south bridge chip, north bridge chip, graphic chip, network chip, or hard drive controller chip. In the following specific embodiments, the CPU is taken as the most preferred embodiment of the present invention. The accompanying drawings are used for reference and illustration only, instead of limiting the present invention.

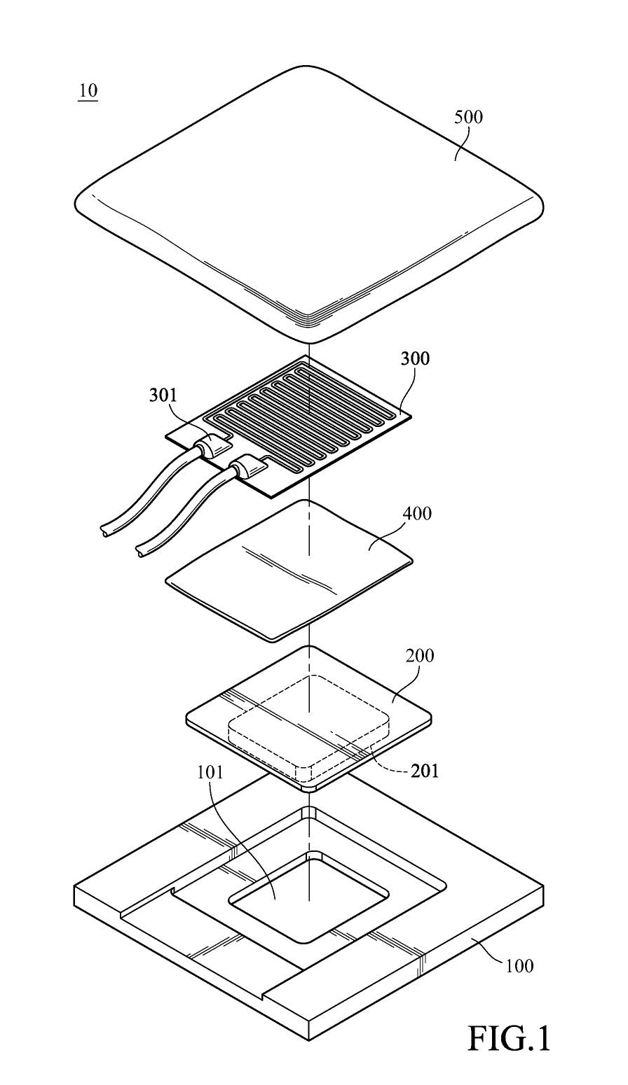

FIG. 1 is an exploded view of a structure of a chip-like heat source equipment according to a first embodiment of the present invention. In FIG. 1, the chip-like heat source equipment 10 of the present invention includes a simulation package 100, a thermal conductor 200, a heat source 300, a thermal grease 400, and an insulating pad 500.

The simulation package 100 has an accommodation space and is formed with a through-hole 101. Further, the simulation package 100 is made of a phenolic material added with non-flammable substances to achieve the flame retardant or flame resistance characteristic.

The thermal conductor 200 is a metal bulk disposed in the simulation package 100, and has a simulated heat source region 201 on one side and exposed by the through-hole 101.

The heat source 300 is a thin electric heating sheet disposed on another side of the thermal conductor 200 having the simulated heat source region 201, and has at least one electrical contact 301, for receiving a power source provided by a power supply or an electric power system of a building and generating heat energy.

The thermal grease 400 is, for example, a solder paste disposed between the thermal conductor 200 and the heat source 300, such that the heat energy generated by the heat source 300 is rapidly transferred to the thermal conductor 200.

The insulating pad 500 is covered on the other side of the thermal conductor 200 having the simulated heat source region 201 and the heat source 300, such that the heat energy generated by the heat source 300 is transferred to the simulated heat source region 201 via the thermal conductor 200. Moreover, the insulating pad 500 is made of a surface tension formed material, such as a thermal molding compound.

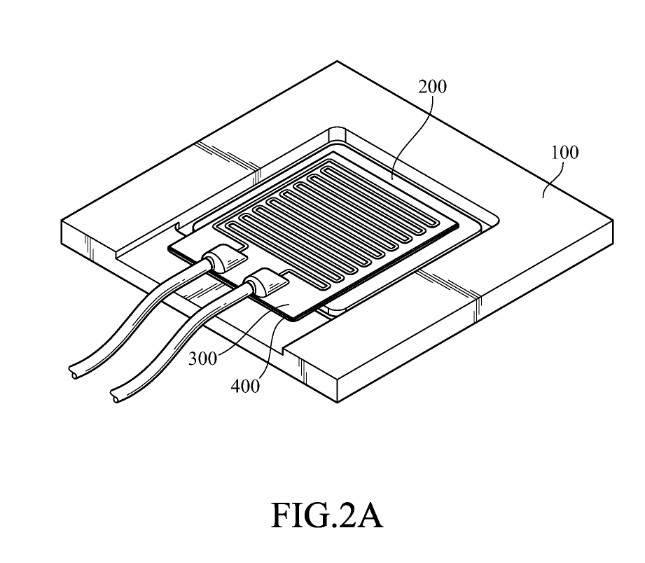

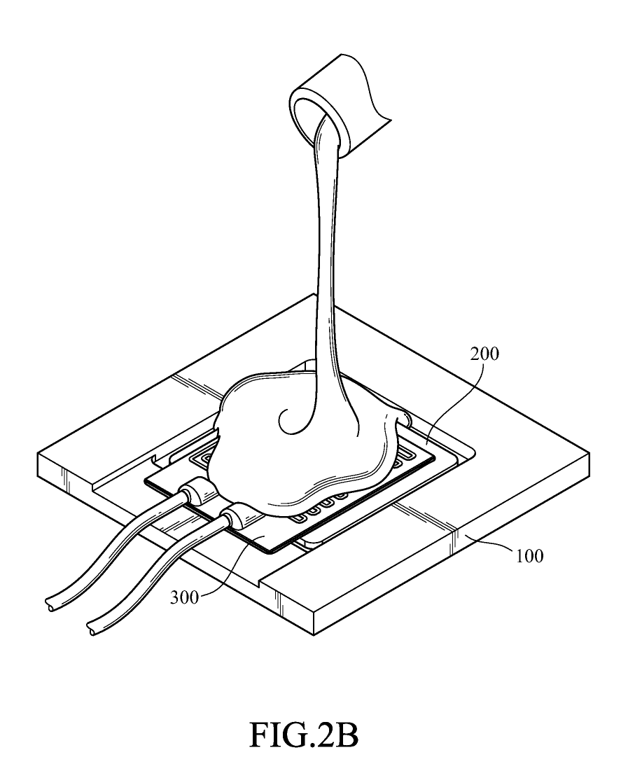

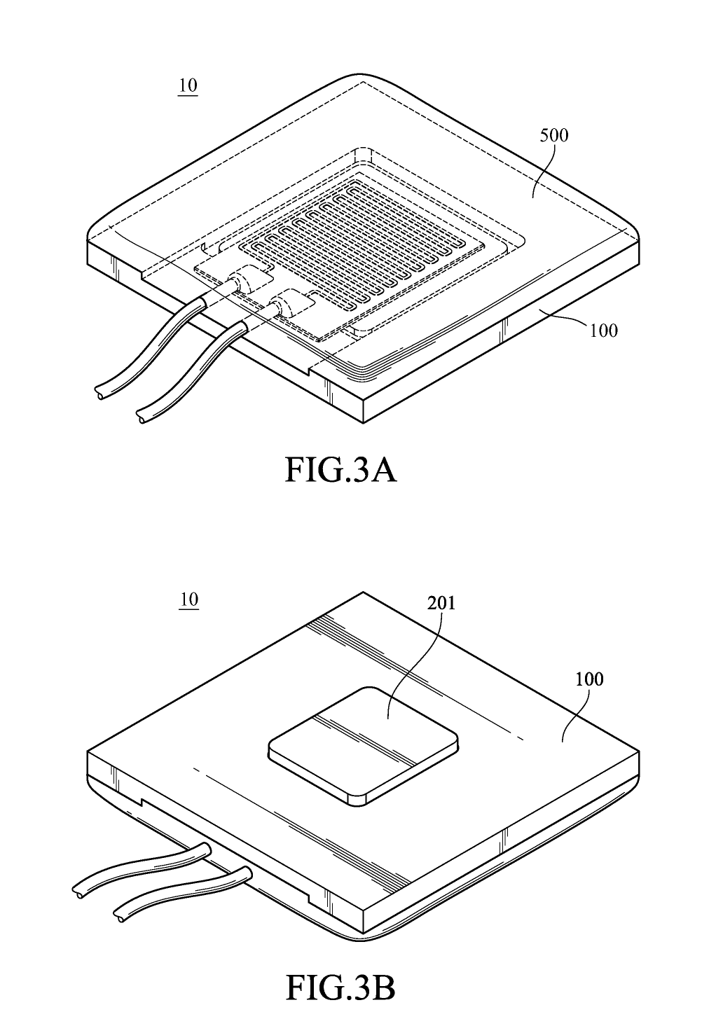

FIGS. 2A and 2B are schematic views illustrating processing of a chip-like heat source equipment according to the first embodiment of the present invention. As shown in the figures, the heat source 300 is adhered to the thermal conductor 200 through the thermal grease 400, the thermal conductor 200 is placed in the through-hole 101 of the simulation package 100, and a thermal molding compound is further cast over the heat source 300. Thus, the other side of the thermal conductor 200 having the simulated heat source region 201 and the heat source 300 are completely covered by the thermal molding compound due to the characteristic of surface tension. In this manner, as shown in FIGS. 3A and 3B, the chip-like heat source equipment 10 having the heat source 300 covered by the insulating pad 500 on one side and the other side exposing the die-like simulated heat source region 201 is formed.

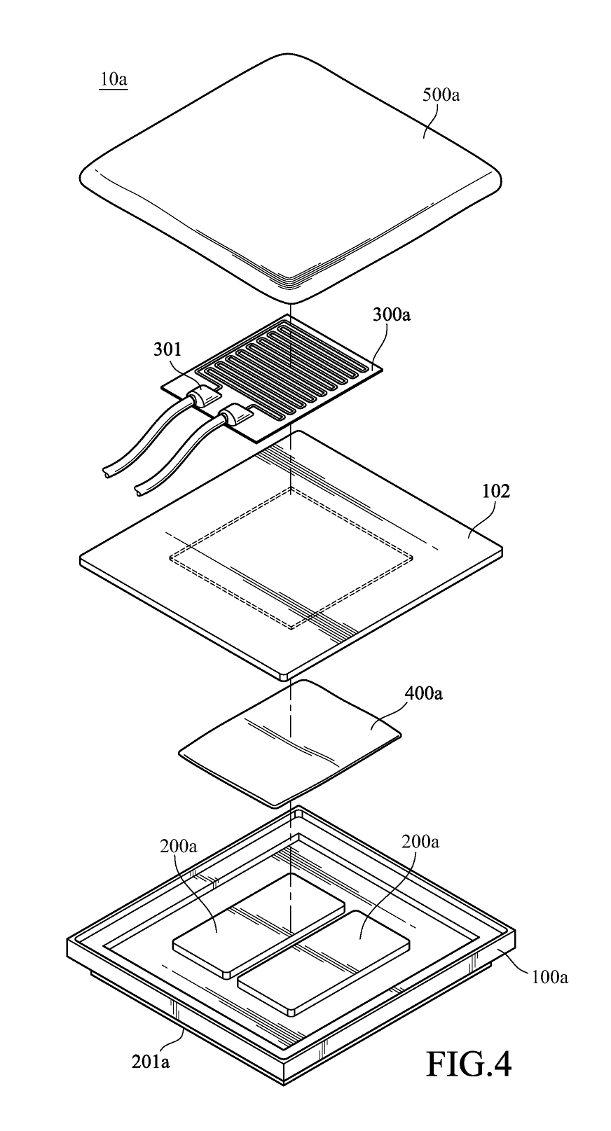

FIG. 4 is an exploded view of a structure of a chip-like heat source equipment according to a second embodiment of the present invention. In FIG. 4, the chip-like heat source equipment 10a of the present invention includes a simulation package 100a, a heat source 300a, a thermal grease 400a, and an insulating pad 500a.

The simulation package 100a is made of copper or copper alloy, and is mechanically processed by milling to form two thermal conductors 200a. In addition, the simulation package 100a and the thermal conductors 200a are integrally formed. The simulation package 100a further has a cover 102 covered on the accommodation space of the simulation package 100a, and thus the simulation package 100a has a closed thermal flow space. Moreover, the cover 102 and the simulation package 100a may be further sealed by a molding compound, so as to achieve a better seal of the simulation package 100a and suit the thermal flow conditions of the real chip. In addition, epoxy may be selected as the molding compound for sealing, and the present invention is not limited thereto.

The simulation package 100a having the two thermal conductors 200a is used to simulate the heat generating states of an electronic device having two processing chips, for example, a dual-core CPU. The number of the thermal conductor 200a varies according to actual situation, and is not limited to this embodiment. The thermal conductors 200a in the simulation package 100a are spaced by a distance from the outer edge of the simulation package 100a, so as to form an air wall for thermal insulation. Moreover, the simulation package 100a has a simulated heat source region 201a on one side corresponding to the thermal conductors 200a.

The heat source 300a is a thin electric heating sheet adhered to another side (i.e., on the cover 102 of the simulation package 100a having the simulated heat source region 201a), and has at least one electrical contact 301, for receiving a power source provided by a power supply or an electric power system of a building and generating heat energy. The thermal grease 400a is, for example, a solder paste, disposed between the cover 102 of the simulation package 100a and the thermal conductors 200a, such that the thermal conductors 200a contact the cover 102, and the heat energy generated by the heat source 300a can be rapidly transferred to the thermal conductors 200a via the simulation package 100a.

The insulating pad 500a is covered on the other side of the simulation package 100a having the simulated heat source region 201a and the heat source 300a, such that the heat energy generated by the heat source 300a is transferred to the simulated heat source region 201a via the thermal conductors 200a. Moreover, the insulating pad 500a is made of a surface tension formed material, such as a thermal molding compound.

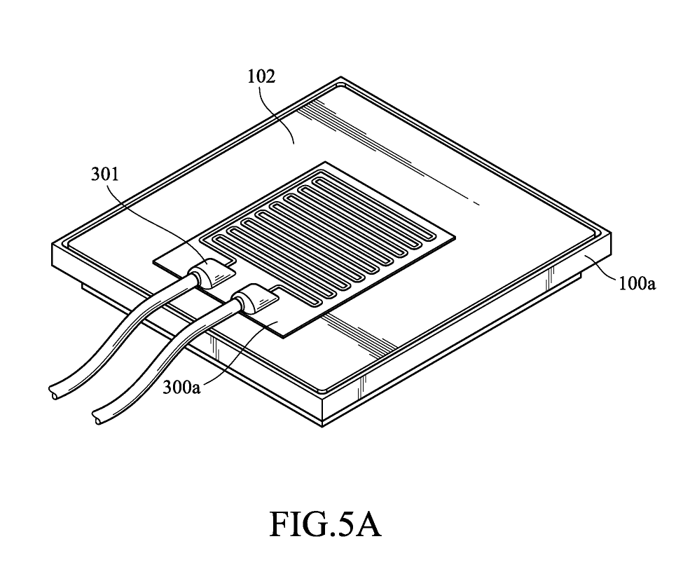

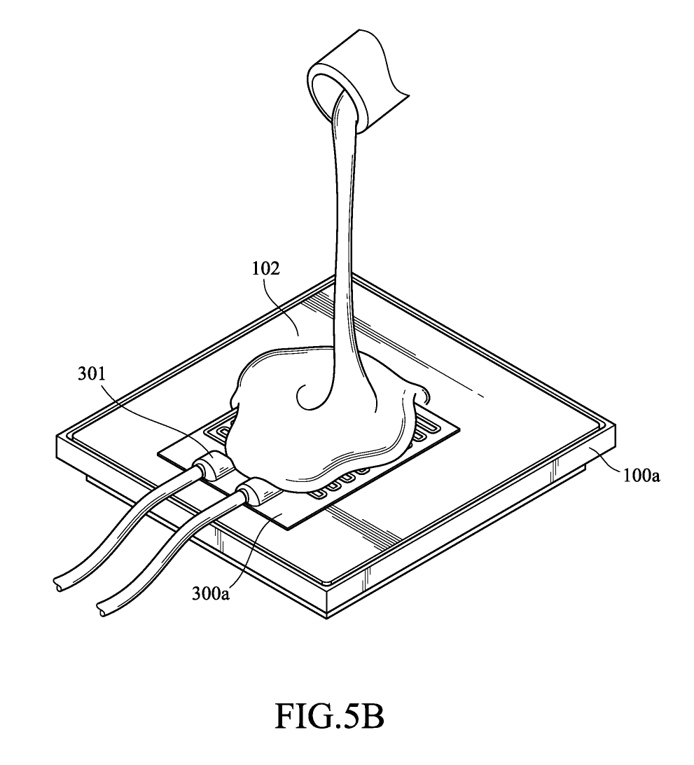

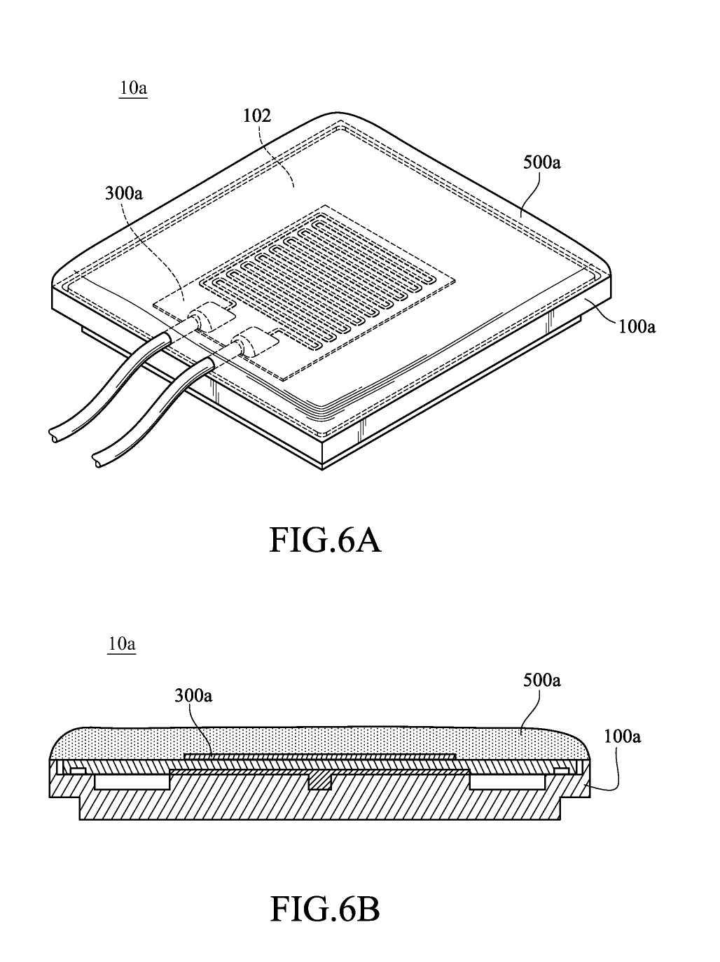

FIGS. 5A and 5B are schematic views illustrating processing of a chip-like heat source equipment according to the second embodiment of the present invention. As shown in the figures, the heat source 300a is adhered to the cover 102, and a thermal molding compound is cast over the heat source 300a. Thus, the other side of the simulation package 100a having the simulated heat source region 201a and the heat source 300a are completely covered by the thermal molding compound due to the characteristic of surface tension. In this manner, as shown in FIGS. 6A and 6B, the chip-like heat source equipment 10a having the dual-die simulated heat source region 201a is formed with the heat source 300a and the other side of the simulation package 100a having the simulated heat source region 201a covered by the insulating pad 500a, and the thermal conductors 200a inside the simulation package 100a thermally contacting the heat source 300a disposed on the simulation package 100a through the thermal grease 400a.

What is claimed is:

1. A chip-like heat source equipment, connected to a power source to generate a heat energy, comprising:
a simulation package, having an accommodation space and formed with a through-hole;
a thermal conductor, disposed in the simulation package, and having a simulated heat source region on one side and exposed by the through-hole;
a heat source, disposed on another side of the thermal conductor having the simulated heat source region, and having at least one electrical contact for receiving the power source and generating the heat energy; and
an insulating pad, covered on the other side of the thermal conductor having the simulated heat source region and the heat source, such that the heat energy generated by the heat source is transferred to the simulated heat source region via the thermal conductor.

2. The chip-like heat source equipment according to claim 1, further comprising a thermal grease disposed between the thermal conductor and the heat source.

3. The chip-like heat source equipment according to claim 1, wherein the thermal conductor is a metal bulk.

4. The chip-like heat source equipment according to claim 1, wherein the heat source is an electric heating sheet.

5. The chip-like heat source equipment according to claim 1, wherein the insulating pad is made of a surface tension formed material.

6. A chip-like heat source equipment, connected to a power source to generate a heat energy, comprising:
a simulation package, having an accommodation space, at least one thermal conductor, and a simulated heat source region corresponding to the thermal conductor on one side;
a heat source, disposed on another side of the simulation package having the simulated heat source region, and having at least one electrical contact for receiving the power source and generating the heat energy; and
an insulating pad, covered on the other side of the simulation package having the simulated heat source region and the heat source, such that the heat energy generated by the heat source is transferred to the simulated heat source region via the thermal conductor.

7. The chip-like heat source equipment according to claim 6, further comprising a thermal grease, wherein the simulation package further has a cover covered on the accommodation space, the heat source is disposed on one side of the cover, and the thermal grease is disposed between the cover and the thermal conductor.

8. The chip-like heat source equipment according to claim 6, wherein the thermal conductor and the simulation package are integrally formed, and the simulation package is a metal bulk.

9. The chip-like heat source equipment according to claim 6, wherein the heat source is an electric heating sheet.

10. The chip-like heat source equipment according to claim 6, wherein the insulating pad is made of a surface tension formed material.
